(19) United States
(12) Patent Application Publication
(10) Pub. No.: US 2004/0045026 A1
(43) Pub. Date: Mar. 4, 2004

(54) In digital or interactive television

(75) Inventors: Ariel Baril, Tel Mond (IL); Ehud Miron, Ramat Efal (IL)

Correspondence Address: G.E. EHRLICH (1995) LTD., C/O ANTHONY CASTORINA, SUITE 207, 2001 JEFFERSON DAVIS HIGHWAY, ARLINGTON, VA, 22202, US

(73) Assignees: Zoe Interactive Ltd.; Matav Cable systems Media Ltd.

(21) Appl. No.: 10/230,301

(22) Filed: Aug. 29, 2002

(51) Int. Cl. H04N 5/445; H04N 7/16

(52) U.S. Cl. 725/59; 725/141; 725/153

(57) ABSTRACT

Apparatus for use in association with channelwise broadcasting of a series of video channels, comprising: a selector for selecting at least one subgroup of said channels as a package, a package display device for arranging displays of each package as at least part of a package channel comprising a mosaic of minimized video screens, ones of said minimized video screens corresponding to ones of said selected channels. The user can select one of the channels to be in focus, so that the sound heard using the browsing channel is that of the channel in focus. The browsing channel may also include interactive content, independently of the channels in the mosaic.

### FIELD OF THE INVENTION

The present invention relates to improvements in digital or interactive television and multicasting in general and mote particularly but not exclusively to packaged and integrated presentation of multicast services.

### BACKGROUND OF THE INVENTION

Currently, digital and analog satellite, and cable, television are able to provide users with large numbers of viewing channels, and in the case of digital services the number of channels can easily reach the two hundred mark. In addition to regular viewing channels, digital television allows interactive services to be supplied, such as chat, games and quizzes. Interactive information services may also be provided over digital television.

Currently, it is known to provide a channel-browsing page, which shows a number of channels simultaneously in small windows, so that the user is able to sec the various channels and then enter the channel he wants. However, with upwards of a hundred channels potentially available at any one time it takes the browsing channel a while to cycle through all available programs. Furthermore with so many channels it is difficult for a user to remember the channel numnbers. In addition, if the user is interested in a particular subject such as news or sport, it is difficult for him to remember all of the relevant channel numbers of channels in order to be able to browse them. Furthermore, although there may be ccrtain channels dedicated to the subject he is interested in, there may also be other channels that occasionally carry programs on the subject, and which he may not take into account simply because he does not know that the program is being carried.

Certain broadcast service providers have responded to the problem by attempting to group channels that belong together so that, for example all of the news channels are numbered in the seventies, or all of the sports channels in the fifties. However, in many cases this has added to the confusion, as it has involved renumbering of channels as viewers have got used to the old numbers. Furthermore, in certain subject areas, categorizing of channels according to divisions long recognized in broadcasting circles, is not necessarily intuitive to the viewing public. In addition, certain channels may intuitively belong to more than one category.

The above is taken from the point of view of the viewer. There is, however, an equivalent problem from the point of view of the broadcaster, namely how to target his programming at the appropriate audience. Given the large number of channels currently available, a large part of the target audience is simply not going to know about the program because program schedules are rapidly becoming too large and unwieldy. However, even if channels were perfectly categorized, no classification scheme is able to take into account the occasional broadcast by a channel of a program in a given subject area.

There is currently no simple way for a user interested in a particular type of channel, to be directed specifically to that type of channel. Even more so is there no way of providing a user with an easy way of determining which channels not dedicated to the subject may be carrying programs on the subject at the current time. In addition, all of the above discussion has related to categorizing of channels according to subject matter, which is at least feasible. However, the ideal for targeting of programs is to categorize according to target audiences. Such is not possible conventionally. Furthermore, there is currently no integration between video channels and interactive services that are not part of individual video channels.

### SUMMARY OF THE INVENTION

According to a first aspect of the present invention there is thus provided apparatus for use in association with channelwise broadcasting of a series of video channels, comprising:

a selector for selecting at least one subgroup of said channels as a package,

a package display device for arranging displays of each package as at least part of a package channel Comprising a mosaic of minimized video screens, ones of said minimized video screens corresponding to ones of said selected channels, and

an interactive content provider for adding to said package interactive content.

According to a second aspect of the present invention there is provided apparatus for use in association with channelwise broadcasting of a series of video channels, comprising:

a selector for selecting at least one subgroup of said channels as a package, and

a package display device for arranging displays of each package as at least part of a package channel comprising a mosaic of minimized video screens, ones of said minimized video screens corresponding to ones of said selected channels, wherein each of said minimized video screens is user selectable, and wherein said package channel is operable to emit sound corresponding to a selected one of said channels in said package.

Preferably, said package channel is operable to lead to a full screen display of any one of said channels in said package via a furter user selection of the corresponding minimized screen.

Preferably, said package channel is further operable to supply an interactive service alongside said minimized video screens in said mosaic.

Preferably, said interactive service comprises an interactive game.

Preferably, said interactive service comprises messaging functionality.

Preferably, said package channel is operable to allow one of said minimized screens to be selected for sound whilst said interactive service is active.

Preferably, said selector is operable to dynamically select channels for inclusion in said package.

Preferably, said dynamic selection comprises selecting channels automatically based on obtained channel viewing data.

The apparatus may comprise using said obtained channel viewing data to group said channels according to discernable groupings of users, thereby to define packages for said discernable groupings.

Preferably, said selector is responsive to user specific data, thereby to define user specific packages.

Preferably, said selector is responsive to user specific data, thereby to refine a package for a specific user.

Preferably, channels have respective channel content subject matter and wherein said at least one package comprises channels selected according to said respective channel content subject matter.

Preferably, said channels comprise programs having respective program content and wherein said at least one package comprises channels dynamically selected according to respective program content.

Preferably, said channelwise broadcasting comprises a browsing channel having minimized video screens and wherein said package display device is operable to use those of said minimized video screens corresponding to said selected channels from which to form said mosaic.

Preferably, said selector is operable to select channels for a plurality of packages overlap being permitted between packages such that a given channel is selectable for more than one of said plurality of packages.

Preferably, said package channel comprises minimized video screens for a plurality of packages, and wherein said package channel is operable to be interactive with a user to select ones of said minimized video screens for display.

According to a third aspect of the present invention there is provided a method of presenting broadcast channels in user friendly manner, the method comprising:

packaging at least some of said channels into at least one package,

providing a mosaic display combining each channel in said package for simultaneous display,

providing said mosaic display with selection functionality to allow channels to be selected from said mosaic display, and

providing interactive content in association with said package.

Preferably, said mosaic display is operable to emit sound corresponding to a selected one of said channels.

Preferably, said mosaic display is operable to lead to a fill screen display of any one of said channels in said package via a further user selection thereof.

Preferably, said mosaic display is further operable to include an interactive service simultaneously with said minimized video screens.

Preferably, said interactive service comprises an interactive game.

Preferably, said interactive service comprises messaging functionality.

Preferably, said mosaic display is operable to allow one of said minimized screens to be selected for sound whilst said interactive service is active.

The method may comprise dynamically selecting channels for inclusion in a respective package.

Preferably, said dynamically selecting comprises automatically selecting channels based on obtained channel viewing data.

The method may comprise using said obtained channel viewing data to group said channels according to discernable groupings of users, thereby to define packages for said discernable groupings.

The method may comprise selecting channels for respective packages responsively to user specific data, thereby to define user specific packages.

The method may comprise selecting channels responsively to user specific data, thereby to refine a package for a specific user.

Preferably, channels have respective channel content subject matter and comprising selecting channels for a package according to said respective channel content subject matter.

Preferably, said channels comprise programs having respective program content and comprising dynamically selecting channels for a package according to respective program content.

Preferably, said channelwise broadcasting comprises a browsing channel having minimized video screens and wherein said method comprises selecting minimized video screens corresponding to said selected channels from which to form said mosaic.

The method may comprise allowing a given channel to be included in a plurality of packages.

The method may comprise forming a package channel containing minimized versions of channels for each of a plurality of packages, and wherein said package channel is operable to be interactive with a user to select ones of said minimized video screens for display.

According to a fourth aspect of the present invention there is provided, in a broadcast of a plurality of video channels together with interactive services, the use of a browsing channel to display a selection of channels in miniature, said selection constituting a package of channels, and simultaneously to provide interactive content associated with said package and independent of individual ones of said channels in said package.

Preferably, each channel of said package is interactive to obtain interactive content relating to said channel.

Preferably, said package interactive content comprises a messaging service.

Preferably, said browsing channel comprises a plurality of user selectable packages, each package having distinctive interactive content.

Preferably, said package interactive content comprises a data push service.

Preferably, said package interactive content comprises a game service.

Preferably, said package interactive content comprises an interactive quiz.

Preferably, in said channels in said package are individually selectable.

Preferably, said interactive browsing channel comprises sound for each channel in said selection, and wherein said browsing channel is operable to emit sound corresponding to a respective user selected channel.

### BRIEF DESCRIPTION OF THE DRAWINGS

The present embodiments provide for the ability to arrange television channels into packages or sub-directories, each package preferably having its own browsing and selecting channel. In a preferred embodiment the packages are dynamically defined, either by the service provider or by the user or by a combination of both. The channels, and particularly the browsing and selecting channels, are preferably designed to allow integration with interactive services such as data push type services, SMS-based services such as message boards, and games.

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified block diagram showing channel packaging apparatus operative in accordance with a first preferred embodiment of the present invention,

FIG. 2 is a simplified schematic view of a channel package browsing screen of the kind that may be generated using the apparatus of FIG. 1,

FIG. 3 is a simplified schematic diagram of a miniaturized interactive channel view for use in the browsing screen of FIG. 2, and

FIG. 4 is a simplified diagram showing an animated closing process for the miniaturized interactive channel view of FIG. 3.

### DESCRIPTION OF THE PREFERRED EMBODIMENTS

Before explaining at least one embodiment of the invention in detail it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and technology employed herein is for the purpose of description and should not be regarded as limiting.

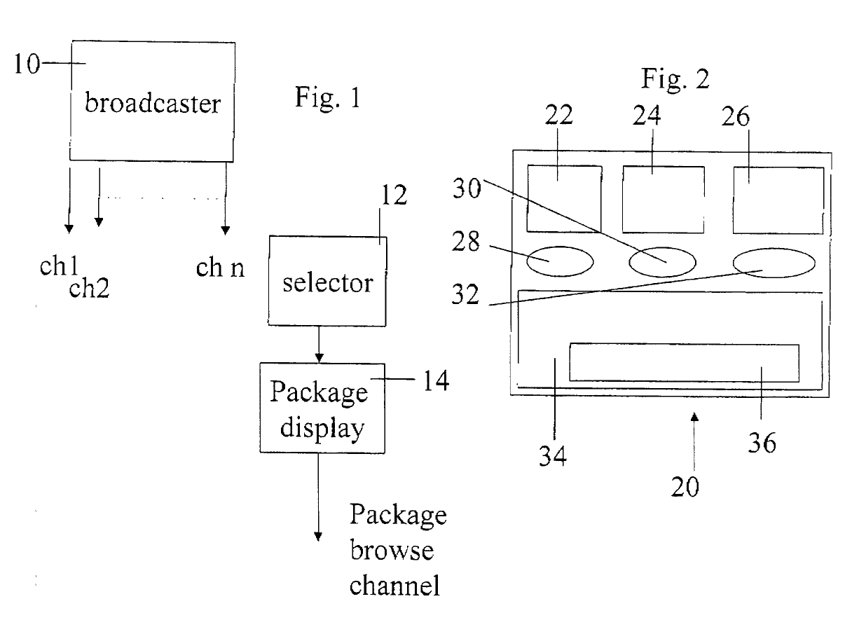

Reference is now made to FIG. 1, which is a simplified block diagram showing apparatus for use in association with channelwise broadcasting of a series of video channels. A broadcasting unit 10 broadcasts a series of video channels, ch1 . . . ch n, which are typically delivered via cable or via satellite to subscribers. Some of the channels are interactive, thus requiring a return channel from the subscriber to the broadcaster. Such a return channel can be provided via the broadcast medium in the case of cable, and in the case of satellite, various possibilities exist including the use of telephone or Internet.

The apparatus of the preferred embodiment comprises a selector 12 which selects several channels as a channel sub-directory or package. In a first preferred embodiment the channels for the package are chosen in advance and the package content remains static. A package may be defined, of youth channels or of sport channels, or of film channels or of news channels or any other arrangement the broadcaster believes will be of interest to viewers, and package display unit 14 arranges the selected channels of the package into a mosaic of miniaturized views, as will bc explained in greater detail below. The mosaic is preferably broadcast or arranged for broadcast as a further channel, hereinbelow referred to as a package browsing channel. FIG. 2 is a simplified schematic of a screen display 20 of such a package browsing channel. The package browsing channel preferably displays a mosaic of minimized versions or views 22-26 of the selected channels in the package. FIG. 2 shows three channels in the mosaic by way of example only and any number may be selected as long as the minimized channels are large enough to convey information to the viewer. A preferred embodiment in fact displays four simultaneous charnels. The browsing channel is preferably interactive so that the user can select channels directly from the screen, and each minimized channel 22-26 may have a selection region 28-32 associated therewith to light up in the event of selection of the channel, or to indicate interaction choices with the channel and the like.

If the package includes more channels than can be fitted on the screen, then either the screen nay automatically cycle between channels or user interaction may be used to move to new parts of the screen, as will be described in greater detail below.

Typically, the series of broadcast channels ch1 . . . ch n includes an overall browsing channel which displays miniaturized views of individual channels in a mosaic. The overall browsing channel typically does not show all of the channels in a single screen but rather divides them into several screens which it cycles between.

In a preferred embodiment, the display arranging unit 14 simply takes miniaturized views from the overall browsing channel for use in the package browsing channel.

In a preferred embodiment of the present invention several packages are defined. However it is not necessary to define a separate browsing channel for each. Rather a single browsing channel may be defined to display each of the miniaturized views of all of the packages, and logic, either at the user end or at the sending end, selects which part of the package browsing channel is currently displayed.

As mentioned above, the browsing channel is preferably interactive, and the remote control, combined with sot top box functionality, can be used to select channels from the mosaic. Selection in the preferred embodiments may be on two levels. On one level, referred to as focus, the selected minimized view is the live channel of the mosaic. For example sound may heard from the channel currently in focus whilst all the others are silent, and other interactions from the user are applied specifically to the channel currently in focus. Which of the channels in the mosaic is currently in focus may be indicated via the corresponding selection region 28 . . . 32, or for example by enlargement or brightening of the selected channel.

The in-focus channel may be subjected to further interactions such as switching to the corresponding full channel. Other functions may also be provided as interactions with the in focus channel. For example the title or further information about a current program may be made available, or the schedule for the channel for a specified period may be obtainable.

Referring again to FIG. 2, the package channel may further allow an interactive service to be provided alongside the minimized video screens in the mosaic. The interactive service is preferably provided via an interactive service window 34, and currently contemplated are games and quizzes, an information push service and various SMS based services such as message boards and the like. However, any kind of interactive service or combinations of different interactive services may be considered. The interaction window 34 may have an interaction region 36 indicating currently available interactions, such as available answers to quiz questions, an instruction to move onto the next screen, or other available services such as chat, message boards and the like.

In a further preferred embodiment of the present invention, the interactive service that is provided in window 34 is related to the subject matter of the package. Thus a news package may have a news push service in window 34 showing news flashes or a series of news pages that the user can navigate between. A music package may for example carry music quizzes and items of topical interest in the music world.

Preferably, one of the minimized screens can be selected for sound whilst the interactive service screen 34 is active. Thus a user can listen to music on his favorite music channel whilst answering quiz questions or the like, for example.

The use of packages as described above is advantageous in solving the problems described in the background. Thus the viewer interested in say a news channel but not being sure which news channel he wants, or not remembering the channel number of the specific news channel he wants, simply selects the news browsing channel, in order to see all available news channels, and he is able to select from the browsing channel the one he want. He is no longer required to remember specific channel numbers for the various news channels.

In the embodiment described above, the channel packages are static. Packages such as a news package, a youth package and the like may be expected to remain relatively constant except for the occasional exchange of channel carried by the broadcaster. However, in a further preferred embodiment, channel packages may be dynamic. Thus a broadcaster may provide a package of current viewing recommendations, or of soap operas or of nature programs, and such a package may be based on individual program content so that a channel is selected for the package for the duration of an individual program. Additionally, the broadcaster may provide packages aimed at categories of viewers, and these too may be dynamically defined based on individual programs.

Furthermore, in a preferred embodiment, a mixture of permanent and dynamic packaging of channels may be provided. Thus, a package such as a soap opera package may have a channel showing mainly soap operas as a permanent member, with other channels being added to the package for the duration of any soap operas that they show. Likewise a youth package may include music and fashion channels as permanent members with other channels being added and taken away dynamically as they show youth orientated programming.

Such dynamic package formation may be carried out manually. Alternatively it may be carried out automatically, based for example on key words in a program's description.

In a further preferred embodiment, dynamic selection may be carried out automatically based on obtained or forecast channel viewing data. Such a technique may be useful in the case of a package of most popular recommendations.

In a further preferred embodiment of the present invention, packages may be designed for particular parts of the audience. Reference has already been made above to a youth channel, and program viewing data may be used to determine which programs are likely to be of interest to which group of viewers and to package the channel accordingly. Such a process may be carried out manually. Alternatively it may be carried out automatically, based on such techniques as data mining.

In a further preferred embodiment of the present invention, the selector 12 may select channels for packaging based on user specific data. In the simplest sense the user specific data may relate to channels a particular user has not subscribed to and a given package as displayed at an individual subscriber may be set to display only those channels of the package to which the user actually subscribes. Typically, the non-subscribed channel may simply be blocked from the mosaic in the same way that the corresponding full channel is conventionally blocked from receipt by the user. However, it is also contemplated that the user is able to construct his own customized list of channels. As mentioned above, the package browsing channel is preferably constructed of channels from several packages, and processing at the user end determines which channels are displayed. Thus, providing a customized package of the channels broadcast on the browsing channel is achievable without undue demand on system bandwidth.

It is noted that the same channel may appear in more than one package. For example a popular youth oriented soap opera may appear simultaneously in a youth package, a package of most popular programs and a soap opera package.

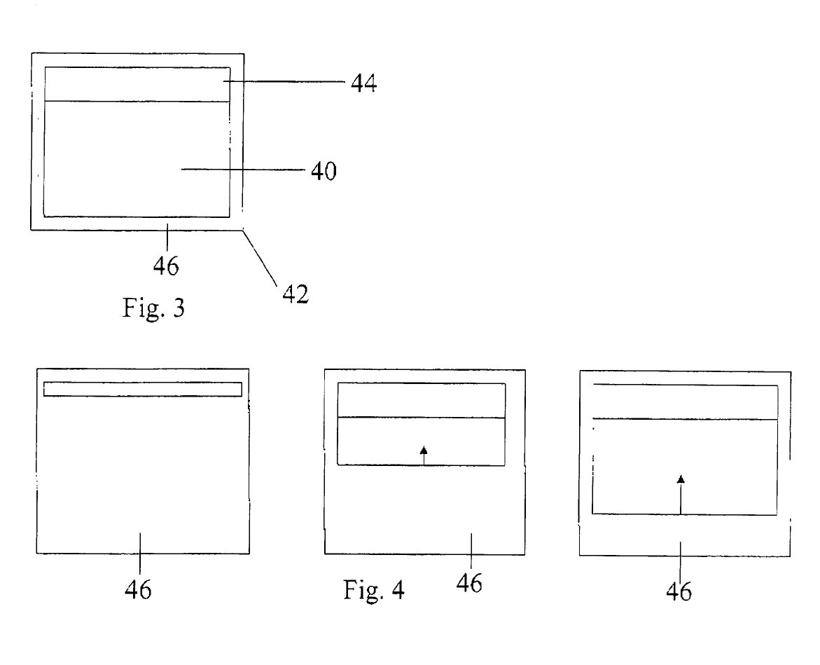

Reference is now made to FIG. 3, which is a simplified schematic diagram showing a preferred construction of a miniaturized video channel display for placement in the package-browsing screen. The display comprises a channel view region 40 surrounded by a frame region 42. An upper part 44 of channel view region 40 is an interaction indicator, and indicates whether the channel is in focus or not. It may also contain buttons indicating possible interactions. Preferably it also displays the name of the channel.

Upon selection of a particular channel, the other channels preferably close as indicated in FIG. 4, where the lower edge 46 of frame 42 moves upwards to engulf the entire view. The selected channel may then take over the entire screen. Upon selection of a further set of channels, the channels may either close as described above or they may move sideways to admit the new channels in a preferred embodiment, both of the above occur. The channels first close by raising of the lower frame edge and then the channels move sideways to admit the new channel or channels.

As well as showing interaction options in association with the channels, interaction options may be displayed in a banner at the top or bottom of the screen. The content of the banner may be static or may change in accordance with the status of the screen. Interaction buttons, whether in the channel interaction region, or the interactive service interaction region or on the banner, are preferably color coded to emphasize their content.

There is thus provided a system for packaging of channels for ease of browsing and finding channels from the point of view of the user and for ease of targeting from the point of view of the broadcaster. There is also provided integration between viewing channels and interactive services.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Apparatus for use in association with channelwise broadcasting of a series of video channels, comprising:
a selector for selecting at least one subgroup of said channels as a package,
a package display device for arranging displays of each package as at least part of a package channel comprising a mosaic of minimized video screens, ones of said minimized video screens corresponding to ones of said selected channels, and
an interactive content provider for adding to said package interactive content.

2. Apparatus for use in association with channelwise broadcasting of a series of video channels, comprising:
a selector for selecting at least one subgroup of said channels as a package, and
a package display device for arranging displays of each package as at least part of a package channel comprising a mosaic of minimized video screens, ones of said minimized video screens corresponding to ones of said selected channels, wherein each of said minimized video screens is user selectable, and wherein said package channel is operable to emit sound corresponding to a selected one of said channels in said package.

3. The apparatus of claim 2, wherein said package channel is operable to lead to a full screen display of any one of said channels in said package via a further user selection of the corresponding minimized screen.

4. The apparatus of claim 2, wherein said package channel is further operable to supply an interactive service alongside said minimized video screens in said mosaic.

5. The apparatus of claim 4, wherein said interactive service comprises an interactive game.

6. The apparatus of claim 4, wherein said interactive service comprises messaging functionality.

7. The apparatus of claim 5, wherein said interactive service comprises messaging functionality.

8. The apparatus of claim 4, wherein said package channel is operable to allow one of said minimized screens to be selected for sound whilst said interactive service is active.

9. The apparatus of claim 2, wherein said selector is operable to dynamically select channels for inclusion in said package.

10. The apparatus of claim 9, wherein said dynamic selection comprises selecting channels automatically based on obtained channel viewing data.

11. The apparatus of claim 10, comprising using said obtained channel viewing data to group said channels according to discernable groupings of users, thereby to define packages for said discernable groupings.

12. The apparatus of claim 2, wherein said selector is responsive to user specific data, thereby to define user specific packages.

13. The apparatus of claim 2, wherein said selector is responsive to user specific data, thereby to refine a package for a specific user.

14. The apparatus of claim 2, wherein channels have respective channel content subject matter and wherein said at least one package comprises channels selected according to said respective channel content subject matter.

15. The apparatus of claim 2, wherein said channels comprise programs having respective program content and wherein said at least one package comprises channels dynamically selected according to respective program content.

16. The apparatus of claim 2, wherein said channelwise broadcasting comprises a browsing channel having minimized video screens and wherein said package display device is operable to use those of said minimized video screens corresponding to said selected channels from which to form said mosaic.

17. The apparatus of claim 2, wherein said selector is operable to select channels for a plurality of packages, overlap being permitted between packages such that a given channel is selectable for more than one of said plurality of packages.

18. The apparatus of claim 2, wherein said package channel comprises minimized video screens for a plurality of packages, and wherein said package channel is operable to be interactive with a user to select ones of said minimized video screens for display.

19. A method of presenting broadcast channels in user friendly manner, the method comprising:
packaging at least some of said channels into at least one package,
providing a mosaic display combining each channel in said package for simultaneous display,
providing said mosaic display with selection functionality to allow channels to be selected from said mosaic display, and
providing interactive content in association with said package.

20. The method of claim 19, wherein said mosaic display is operable to emit sound corresponding to a selected one of said channels.

21. The method of claim 19, wherein said mosaic display is operable to lead to a full screen display of any one of said channels in said package via a further user selection thereof.

22. The method of claim 19, wherein said mosaic display is further operable to include an interactive service simultaneously with said minimized video screens.

23. The method of claim 22, wherein said interactive service comprises an interactive game.

24. The method of claim 22, wherein said interactive service comprises messaging functionality.

25. The method of claim 23, wherein said interactive service comprises messaging functionality.

26. The method of claim 22, wherein said mosaic display is operable to allow one of said minimized screens to be selected for sound whilst said interactive service is active.

27. The method of claim 19, comprising dynamically selecting channels for inclusion in a respective package.

28. The method of claim 27, wherein said dynamically selecting comprises automatically selecting channels based on obtained channel viewing data.

29. The method of claim 28, comprising using said obtained channel viewing data to group said channels according to discernable groupings of users, thereby to define packages for said discernable groupings.

30. The apparatus of claim 19, comprising selecting channels for respective packages responsively to user specific data, thereby to define user specific packages.

31. The method of claim 19, comprising selecting channels responsively to user specific data, thereby to refine a package for a specific user.

32. The method of claim 19, wherein channels have respective channel content subject matter and comprising selecting channels for a package according to said respective channel content subject matter.

33. The method of claim 19, wherein said channels comprise programs having respective program content and comprising dynamically selecting channels for a package according to respective program content.

34. The method of claim 19, wherein said channelwise broadcasting comprises a browsing channel having minimized video screens and wherein said method comprises selecting minimized video screens corresponding to said selected channels from which to form said mosaic.

35. The method of claim 19, comprising allowing a given channel to be included in a plurality of packages.

36. The method of claim 19, comprising forming a package channel containing minimized versions of channels for each of a plurality of packages, and wherein said package channel is operable to be interactive with a user to select ones of said minimized video screens for display.

37. In a broadcast of a plurality of video channels together with interactive services, the use of a browsing channel to display a selection of channels in miniature, said selection constituting a package of channels, and simultaneously to provide interactive content associated with said package and independent of individual ones of said channels in said package.

38. The use of claim 37, wherein each channel of said package is interactive to obtain interactive content relating to said channel.

39. The use of claim 37, wherein said package interactive content comprises a messaging service.

40. The use of claim 37, wherein said browsing channel comprises a plurality of user selectable packages, each package having distinctive interactive content.

41. The use of claim 37, wherein said package interactive content comprises a data push service.

42. The use of claim 37, wherein said package interactive content comprises a game service.

43. The use of claim 37, wherein said package interactive content comprises an interactive quiz.

44. The use of claim 37, wherein said channels in said package are individually selectable.

45. The user of claim 44, wherein said interactive browsing channel comprises sound for each channel in said selection, and wherein said browsing channel is operable to emit sound corresponding to a respective user selected channel.
